(19) United States
(12) Patent Application Publication
(10) Pub. No.: US 2007/0147671 A1
(43) Pub. Date: Jun. 28, 2007

(54) Analyzing radiological image using 3D stereo pairs

(75) Inventors: Joseph P. Di Vincenzo, Rochester, NY (US); John R. Squilla, Rochester, NY (US); Daniel P. Schaertel, Webster, NY (US); Nelson A. Blish, Rochester, NY (US)

Correspondence Address: Mark G. Bocchetti;Patent Legal Staff, Eastman Kodak Company, 343 State Street, Rochester, NY, 14650-2201, US

(73) Assignee: Eastman Kodak Company

(21) Appl. No.: 11/315,758

(22) Filed: Dec. 22, 2005

(51) Int. Cl. G06K 9/00

(52) U.S. Cl. 382/128; 382/154

(57) ABSTRACT

A system for analyzing radiological images using three-dimensional (3D) stereo pairs comprises capturing 3D image data; storing the 3D image data; segmenting the 3D image data; creating a model from the segmented 3D image data; creating a first 3D volumetric monocular-view image for the current model position; rotating the model a prescribed amount and creating a second 3D volumetric monocular-view image for the rotated position; creating the 3D stereo pair using the first and second 3D volumetric monocular-view images; and viewing the 3D stereo pair on a 3D stereo viewer.

### FIELD OF THE INVENTION

This invention relates in general to medical images and in particular to viewing of three-dimensional (3D) stereo pairs.

### BACKGROUND OF THE INVENTION

It is desirable to provide medical professionals with a system for viewing true three-dimensional (3D) stereo images captured using 3D radiographic modalities. Examples of medical radiographic modalities commonly used to capture 3D medical images are: CT-scanners, MR-scanners, PET-scanners, and cone-beam CT scanners.

The scanner energy source(s) and imaging detector(s) are located at specific geometric positions with respect to the 3D object to be scanned. The positions depend on the object being scanned, the physics of the energy source and imaging detector, and the structures in the scanned 3D object to be viewed in the images. The scanner captures 3D image data of the object being scanned by taking a time-sequence of images while moving the energy source(s) and imaging detector(s) through a prescribed motion sequence (e.g. a helical path for CT-scanners) of known positions around the object. Alternately, the object can be moved while the energy source(s) and imaging detector(s) remain stationary.

Image data captured in the previously described method is mathematically transformed (e.g. Radon transforms) from a helical scan (i.e. polar coordinate system) image into the more familiar 3D Cartesian coordinate system. For example, in medicine, 3D CT-scan, MR-scan, and PET-scan data are typically viewed on a piece of radiographic film or high-quality 2D computer monitor as two-dimensional (2D) slices. These 2D slices are represented in one or more of the three orthogonal Cartesian coordinate system views referred to in medicine as the axial (i.e. as viewed along the body's major axis), coronal (i.e. as viewed from the front/back), and sagittal (i.e. as viewed from the side) views. Each of these axial, coronal, sagittal views represents a viewer perspective along one of the three Cartesian coordinate system axes defined with respect to the scanner's geometry. Alternately for specialized viewing applications, the user can define an “oblique view” axis to reorient the Cartesian coordinate system views to one different to those provided by the traditional scanner-referenced Cartesian coordinate system.

Image processing is usually performed to digitally adjust the radiographic image appearance to improve the ability of the radiologist or clinician to see the areas of interest in the image. This processing is dependent on many factors including the study being performed, the body part being imaged, patient characteristics (e.g. weight, age, etc.), clinician preferences, and so forth. Examples of this image processing known in the art include adjustments to the image sharpness, contrast, brightness, and density-specific image detail.

In addition to looking at the 2D axial, coronal, and sagittal slices of an object, it is often desirable to visualize a 3D volumetric rendering of the object to get a better understanding of the positioning of the object's features in 3-space. This is especially useful for clinicians that are using these radiographic images to prepare for clinical procedures such as surgery, interventional radiology, and radiation oncology procedures. The increasing availability of hardware-accelerated 3D computer graphics engines for rendering computer-generated 3D models makes it advantageous to construct a 3D model from patient medical images captured with the previously described 3D medical radiographic image capture modalities.

It is well known to create a 3D model from this information. A high-level description of the 3D model creation process includes segmenting the image into regions and representing the regions spatially using mathematical models. References known in the prior art include the following.

U.S. Patent Application Publication No. 2003/0113003 A1 (Cline et al.) describes a method and system for segmentation of medical images.

U.S. Pat. No. 5,319,551 (Sekiguchi et al.) describes a region extracting method and 3D display method.

U.S. Pat. No. 6,373,918 (Wiemker et al.) describes a method for the detection of contours in an X-Ray image.

U.S. Pat. No. 5,796,862 (Pawlicki et al.) describes an apparatus and method for identification of tissue regions in digital mammographic images.

U.S. Pat. No. 5,268,967 (Jang et al.) describes a method for automatic foreground and background detection in digital radiographic images.

U.S. Patent Application Publication No. 2005/0018893 A1 (Wang et al.) describes a method for segmenting a radiographic image into diagnostically relevant and diagnostically irrelevant regions.

U.S. Pat. No. 6,542,628 (Muller et al.) describes a method for detection of elements of interest in a digital radiographic image.

U.S. Pat. No. 6,108,005 (Starks et al.) describes a method for converting two-dimensional images to 3D images by forming at least two images from one source image where at least one image has been modified relative to the source image such that the images have a different spatial appearance.

U.S. Pat. No. 6,515,659 (Kaye et al.) describes an image processing method for converting two-dimensional images into 3D images by using a variety of image processing tools that allow a user to apply any number or combination of image pixel repositioning depth contouring effects or algorithms to create 3D images.

Despite the ability to create 3D medical image models, the image displays commonly used for medical image viewing are generally based on 2D display technology (e.g. paper, radiographic film, computer monitors and projection systems). This 2D display media is limited to displaying pixels in a single plane, with the same planar image being viewed by both eyes of the human observer.

It is well known that fine artists and, more recently, graphic artists have developed techniques for creating the illusion of 3D depth when displaying images on 2D display media. These techniques include: forced perspective, shape-from-shading, relative size of commonly known objects, rendering detail, occlusion and relative motion. These techniques work by creating an optical illusion, triggering several psychophysical cues in the human eye-brain system that are responsible for creating the human viewer's experience of depth perception in the viewed scene. However, these artistic techniques for displaying 3D volumetrically rendered images on a single, unaltered planar 2D display media device can not produce binocular disparity in the human eye-brain system. Binocular disparity is one of the dominant psychophysical cues necessary to achieve true stereo depth perception in humans.

It is well known in the art that stereo imaging applications allow for viewing of 3D images in true stereo depth perception using specialized stereo pair image viewing equipment to produce binocular disparity. In his paper The Limits of Human Vision, Sun Microsystems, Michael F. Deering describes “a model of the perception limits of the human visual system.”

The idea of utilizing two-dimensional images to create an illusion of three dimensionality, by using image horizontal parallax to present slightly different left and right images to the viewer's left and right eyes, respectively, (i.e. a stereo pair) seems to date back at least to the 16th century, when hand-drawn stereograms appeared. In the 19th century, photographic stereograms of exotic locations and other topics of interest were widely produced and sold, along with various hand-held devices for viewing them. More decently, the ViewMaster® popularized stereo depth perception using a handheld viewer that enabled the observer to view stereo pair images recorded on transparency film.

U.S. Pat. No. 6,515,659 (Kaye et al.) describes an image processing method and system for converting two-dimensional images into realistic reproductions, or recreations of three-dimensional images.

McReynolds and Blythe, Advanced Graphics Programming Techniques Using OpenGL, SIGGRAPH, 1998, describes a method for computing stereo viewing transforms from a graphical model of the 3D object where the left eye view is computed based on transforming from the viewer position (the viewer position is nominally equidistant between the left-eye and right-eye viewing positions with the left- and right-eye viewing angles converging to a point on the surface of the object) to the left-eye view, applying viewing operation to get to viewer position, applying modeling operations, then changing buffers and repeating this sequence of operations to compute the right eye view.

Batchelor, Quasi-stereoscopic Solar X-ray Image Pair, NASA; nssdc.gsfc.nasa.gov/solar/stereo_images.htm, describes a method for computing a quasi-stereoscopic image pairs of the Sun. “The image pair represents a step towards better investigation of the physics of solar activity by obtaining more 3D information about the coronal structures. In the time between the images (about 14 hours) the Sun's rotation provides a horizontal parallax via its rotation. The images have been registered and placed so that the viewer can train the left eye at the left image and right eye at the right image, obtaining a quasi- stereoscopic view, as if one had eyes separated by one tenth the distance from Earth to the Sun. Much of the Sun's coronal structure was stable during this time, so depth can be perceived.”

Wikipedia (http://en.wikipedia.org/wiki/Stereoscopy) summarizes many of the current 3D stereo devices used to produce binocular stereoscopic vision in humans from digital, film, and paper image sources. These include: autostereo viewers, head-mounted microdisplays, lenticular/barrier displays, shutter glasses, colored lens glasses, linearly polarized lens glasses, and circularly polarized lens glasses.

Unfortunately, it is not uncommon for many of these 3D stereo devices to induce eye fatigue and/or motion sickness in users. The cause for these negative physical side effects in users can be explained largely by inconsistencies between the induced binocular disparity and the cues of accommodation (i.e. the muscle tension needed to change the focal length of the eye lens to focus at a particular depth) and convergence (i.e. the muscle tension need to rotate each eye to converge at the point of interest on the surface of the object being viewed).

Technical advances in 3D stereo image viewer design have reduced the magnitude and frequency of occurrence of these negative side effects to the point where they can be used without placing undue stress on medical personnel.

U.S. Pat. No. 6,871,956 (Cobb et al.) and U.S. Patent Application Publication No. 2005/0057788 A1 (Cobb et al.) describe an autostereoscopic optical apparatus for viewing a stereoscopic virtual image comprised of a left image to be viewed by an observer at a left viewing pupil and a right image to be viewed by an observer at a right viewing pupil.

Technology and engineering developments have enabled the potential size and cost of these 3D stereo medical image viewers to be reduced to a level where they are practical to deploy for medical image viewing.

U.S. patent application Ser. No. 10/961,966, filed Oct. 8, 2005, entitled “Align Stereoscopic Display” by Cobb et al. describes a method and apparatus for an alignment system consisting of a viewer apparatus for assessing optical path alignment of a stereoscopic imaging system. The apparatus having a left reflective surface for diverting light from a left viewing pupil toward a beam combiner and a right reflective surface for diverting light from a right viewing pupil toward the beam combiner. The beam combiner directs the diverted light from left and right viewing pupils to form a combined alignment viewing pupil, allowing visual assessment of optical path alignment.

U.S. patent application Ser. No. 11/156,119, filed Jun. 17, 2005, entitled “Stereoscopic Viewing Apparatus” by Cobb et al. describes an optical apparatus for building a small, boom-mountable stereoscopic viewing has a first optical channel with a first display generating a first image and a first viewing lens assembly producing a virtual image, with at least one optical component of the first viewing lens assembly truncated. A second optical channel has a second display generating a second image and a second viewing lens assembly producing a virtual image, with at least one optical component of the second viewing lens assembly truncated along a second side. A reflective folding surface is disposed between the second display and second viewing lens assembly to fold a substantial portion of the light within the second optical channel. An edge portion of the reflective folding surface blocks a portion of the light in the first optical channel. The first side of the first viewing assembly is disposed adjacent the second side of the second viewing lens assembly.

The benefits of viewing 3D stereo medical images are becoming well known. True 3D stereo medical image viewing systems can provide enhanced spatial visualization of anatomical features with respect to surrounding features and tissues. Although radiologists are trained to visualize the “slice images” in 3D in their mind's eye, other professionals who normally work in 3D (e.g. surgeons, etc.) cannot as easily visualize in 3D. This offers the potential for improve the speed of diagnosis, reduce inaccurate interpretations and provide improved collaboration with clinicians who normally perform their work tasks using both their eyes to view natural scenes in 3D (e.g. surgeons).

However, with the ever-increasing resolution (number of slices) of radiology 3D medical image capture modalities, it takes diagnostic radiologists longer, using traditional methods, to review all the “slice” images in each individual radiographic study. This increased resolution makes it harder for radiologists to visualize where structures are with respect to features in adjacent slices. These trends may offer diagnostic radiologists the opportunity to benefit from true 3D stereo medical image viewing as well.

An article in Aunt Minnie entitled 3D: Rendering a New Era, May 2, 2005 states “(Three-dimensional) ultrasound provides more accurate diagnoses for a variety of obstetrical and gynecological conditions, helping physicians make diagnoses that are difficult or impossible using 2D imaging,” said longtime obstetrical ultrasound researcher Dr. Dolores Pretorius of the University of California, San Diego. “(Three-dimensional) ultrasound is valuable in diagnosing and managing a variety of uterine abnormalities.” Compared with MRI, 3D ultrasound has the same capabilities but is faster and less expensive, Pretorius said. Also in that article was this note about accuracy using 3D. “We also use 3D for lung nodules, because it measures more accurately, where the radiologist might get different measurements each time,” Klym said. Dr. Bob Klym is the lead 3D practitioner at Margaret Pardee.

Most recently deployed medical imaging systems capable of capturing and storing 3D medical image data (i.e. Picture Archive and Communication Systems (PACS)) currently have the capability to render a monocular (i.e. non-stereo without horizontal image disparity between left and right eye images) volumetric image view from 3D medical image data and displaying this volumetric rendering on a 2D CRT or LCD monitor. Upgrading these existing systems to compute true stereo image pairs using practices known in the industry would result in one or both of doubling the graphics engine throughput and/or significant software/firmware changes to accommodate the second stereo viewing data stream. Both of these upgrades would add considerable upgrade expense and time for institutions to upgrade their current PACS systems to provide true 3D stereo image viewing for their radiologists and clinicians.

The goal of this invention is to provide a method for leveraging the existing monocular volumetric rendering using the existing 3D graphics engine available in most current PACS medical imaging systems to enable true 3D stereo viewing of medical images with binocular disparity. Another goal of this invention is to enable true 3D stereo viewing without the need to purchase significantly more graphics engine hardware. By using this invention to reduce the cost, time and complexity required to enable existing PACS medical imaging systems to provide true 3D stereoscopic viewing for clinicians, the benefits of this technology can be more rapidly deployed to benefit clinicians and their patients.

### SUMMARY OF THE INVENTION

Briefly, according to one aspect of the present invention a system for analyzing radiological images using 3D stereo pairs comprises capturing, storing, and segmenting the 3D image data. A model is created from the segmented 3D image data. A first 3D volumetric monocular-view image for a current model position is created. The model is rotated a prescribed amount and creates a second 3D volumetric monocular-view image for the rotated position. The 3D stereo pair is created using the first and second 3D volumetric monocular-view images. The 3D stereo pair is viewed on a 3D stereo viewer.

This invention provides a way to produce 3D stereo depth perception from stereo pair images of medical images, with significantly reduced the computational load and provide the potential for adapting an aftermarket true stereo viewer to existing systems providing a single sequence of volumetric rendered monocular views (e.g. the ability to view a volumetric reconstruction of an object on a 2D display device such as a CRT, LCD monitor or television screen). To do this, the computational load is reduced to the order of one rendered 3D volumetric monocular image view per viewing position instead of computing two independent views (i.e. one for each eye view in the stereo viewing system) as has been done in the prior art.

The invention and its objects and advantages will become more apparent in the detailed description of the preferred embodiment presented below.

### BRIEF DESCRIPTION OF THE DRAWINGS

FIG. 1 is a schematic of a prior art stereo pair calculation from 3D image model.

FIG. 2 is a schematic view showing calculation of 3D stereo pairs according to the present invention.

FIG. 3 is a geometric representation of prior art calculations shown in FIG. 1.

FIG. 4 is a geometric representation of calculations according to the present invention shown FIG. 2.

FIG. 5 is a more detailed view of section A shown in FIG. 4.

FIG. 6 is a schematic view showing the monocular view according to the prior art.

FIG. 7 is a superimposed binocular view of the prior art with the present invention.

FIG. 8 shows the micro-stepping methodology of the present invention.

FIG. 9 is a schematic view showing calculation of 3D stereo pairs according to the present invention with the addition of a graphics engine output switch and rotation direction control.

### DETAILED DESCRIPTION OF THE INVENTION

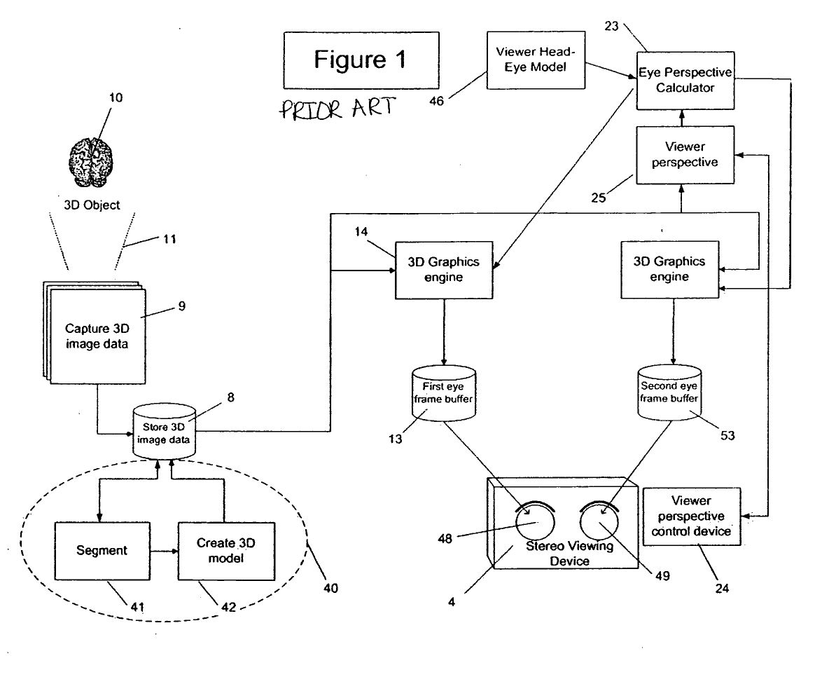

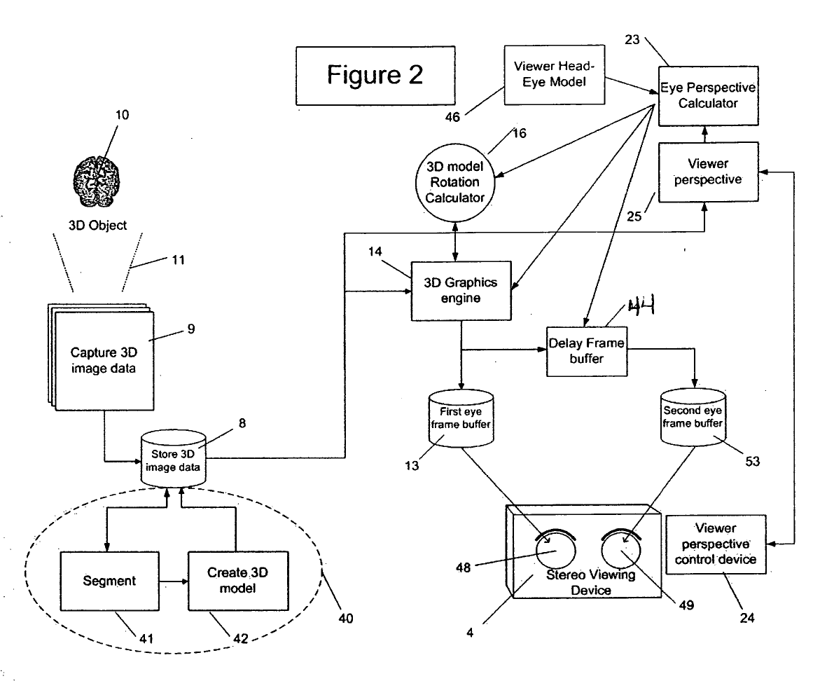

FIG. 1 is a schematic of a prior art stereo pair calculation from 3D image model using 3D stereo pairs and is shown as background for this invention. Many of these components are also used in FIG. 2 and are explained in the context of the present invention. Of particular distinction is the presence of two (2) 3D graphics engines 14 shown in FIG. 1 as prior art. This invention, as 25 described in FIG. 2, uses a single 3D graphics engine 14 with the addition of the 3D model rotation calculator 16 and delay frame buffer 44 not used in the FIG. 1 prior art.

FIG. 2 shows the system of this invention for analyzing medical images 9 using 3D stereo pairs. Medical image data 9 is captured by scanning object 10 using scanner 11 which is capable of producing 3D image data. This medical image data 9 is stored in data storage 8.

Image segmentation 41 is performed on the medical image data 9 resulting in labeled regions of medical image data 9 that belong to the same or similar features of object 10. Image segmentation 41 is based on known medical image segmentation rules as described in the prior art. Examples include threshold-based segmentation algorithms using pixel intensity criteria up through complex image morphology rules including edge finding and region growing. Image segmentation 41 results for medical image data 9 are stored in data storage 8.

High performance 3D graphics engines now widely available from companies such as ATI Technologies, Inc. (www.ati.com) and nVidia Corporation (www.nvidia.com). for use in computers supporting image processing, advanced gaming and medical Picture Archive and Communication Systems (PACS). To improve system performance and take advantage of these high performance graphics engines, a 3D model 42 of object 10 is constructed. The 3D modeling process 40 uses the image segmentation 41 and medical image data 9 to produce the 3D model 42. The 3D model 42 is stored in data storage 8.

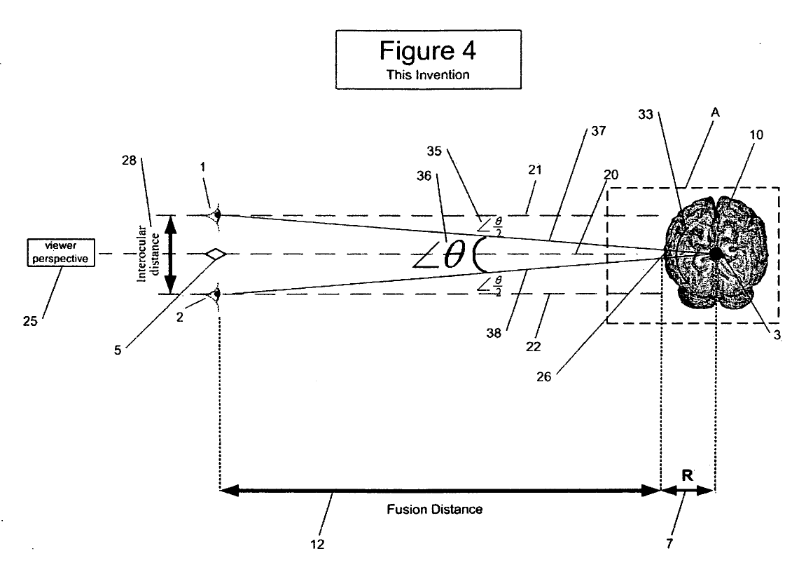

Viewer perspective 25, reference Paul Bourke, Calculating Stereo Pairs; http://astronomy.swin.edu.au/˜pbourke, defines the position and orientation of the viewer with respect to the 3D model 42 of object 10. Viewer perspective 25 is traditionally specified using the 3-degrees of freedom specifying the viewer's position in 3-space (e.g. X, Y, and Z coordinates in a Cartesian coordinate system) and the 3-degrees of freedom specifying the viewer's orientation (i.e. direction of view) from that position in 3-space. FIG. 4 further shows viewer perspective 25 defined from the viewer perspective reference 5 viewing the 3D model 42 of object 10 along viewer perspective line 20 at the fusion distance 12 from the 3D model 42 of object 10.

Returning the FIG. 2, in some applications the viewer perspective 25 may be static with respect to the 3D model 42 of object 10, in which case no viewer perspective control device 24 is required. Generally, the user desires control over the 6-degrees of freedom that define the viewer perspective 25 with respect to the 3D model 42 using a viewer perspective control device 24. Alternately, the 3D model 42 can be repositioned with respect to the viewer perspective 25 using a viewer perspective control device 24.

Viewer perspective control device 24 examples include joysticks, data gloves, and traditional 2D devices such as a computer mouse and keyboard. The viewer perspective control device 24 controls the 3-degrees of freedom specifying the viewer's position in 3-space (e.g. X, Y, and Z coordinates in a Cartesian coordinate system) and the 3-degrees of freedom specifying the viewer's orientation (i.e. direction of view) from that position in 3-space, which combine to specify the viewer perspective 25 in 3-space. Viewer perspective control device 24 controls position and orientation directly or indirectly via other parameters such as velocity or acceleration. For example, flight simulators use a joystick with thrust and rudder controls as the preferred viewer perspective control device 24 to control the plane model's position (i.e. altitude above the ground (Z) and it's projected X and Y position on the earth's surface) and the plane's orientation (i.e. roll, pitch, and yaw) in 3-space.

Viewer head-eye model 46 describes the properties and parameters of the viewing subsystem. The eye model portion of the viewer head-eye model 46 describes viewer first eye 1 and viewer second eye 2 including their physical characteristics and capabilities. These models are well-known in the art and contain parameters such as, but not limited to, field of view, resolution, lens focal length, focus capability, light sensitivity by wavelength and signal-to-noise ratio as is required to predict the response of the first viewer eye 1 and second viewer eye 2 to “viewing” the 3D model 42 of object 10. Michael F. Deering, in his paper The Limits of Human Vision, Sun Microsystems) describes “a model of the perception limits of the human visual system.” The head model portion of viewer head-eye model 46 describes the physical location, orientation, and interaction of one or more viewer eyes with respect to the other viewer eyes as well as with respect to the system's viewer perspective reference. In the present invention, the viewer head-eye model 46 describes the properties of and relationship between viewer first eye 1, viewer second eye 2, and viewer perspective reference 5.

Eye perspective calculator 23 uses the viewer head-eye model 46, viewer perspective 25 and 3D model 42 of object 10 in FIG. 2 to compute the first eye perspective approximation line 37 and first eye field-of-view for viewer first eye 1 and the second eye perspective approximation line 38 and second eye field-of-view for viewer second eye 2 shown in FIG. 4.

The first eye perspective approximation line 37, first eye field-of-view, the second eye perspective approximation line 38, second eye field-of-view, fusion distance 12, interocular distance 28, distance R 7, viewer perspective reference 5, viewer perspective line 20, axis of rotation 3, direction of rotation 33, microstep increment angle 43, angle theta 36 and 3D model 42 of object 10 are used to control the 3D model rotation calculator 16, 3D graphics engine 14, and delay frame buffer 44 in FIG. 2 to maintain the viewing geometry of this invention detailed in FIG. 4. 3D graphics engine 14 renders a 3D volumetric monocular image view 45 (e.g. V1) for the viewer first eye 1 viewing along the first eye perspective approximation line 37 for each microstep increment angle 43.

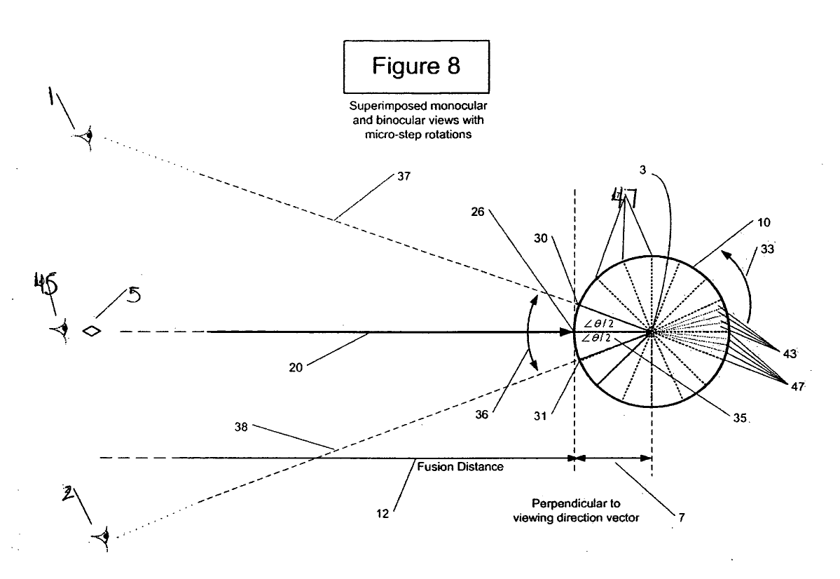

In FIG. 2, the 3D model rotation calculator 16 uses results from eye perspective calculator 23 and the 3D model 42 of object 10 to calculate the microstep increment angle 43, shown in FIG. 8. Microstep increment angle 43 is applied to 3D model 42 by the 3D graphics engine 14 to produce a 3D volumetric monocular image view 45 (e.g. V1) for each microstep increment angle 43, thus forming the sequence of volumetric rendered monocular views 47 of 3D model 42, as shown in FIG. 2 and schematically in FIG. 8.

In FIG. 2, the first eye frame buffer 13 and the delay frame buffer 44 receive the sequence of volumetric rendered monocular views 47 from the 3D graphics engine 14. The first eye frame buffer 13 stores each individual 3D volumetric monocular image view 45 contained in the sequence of volumetric rendered monocular views 47, while that view is transmitted to the 3D stereo viewer 4 for viewing by the viewer first eye 1 through first eyepiece 48. After a period of time, the first eye frame buffer 13 is updated with the next individual 3D volumetric monocular image view 45 from the sequence of volumetric rendered monocular views 47.

Delay frame buffer 44 is implemented as a queue capable of storing one or more individual 3D volumetric monocular image view 45 (i.e. “frames”) and is used to create a time delay before transmitting each individual 3D volumetric monocular image view 45 in the sequence of volumetric rendered monocular views 47 to the second eye frame buffer 53 relative to that same individual 3D volumetric monocular image view 45 being transmitted to the first eye frame buffer 13. The delay duration of the delay frame buffer 44 is computed by eye perspective calculator 23 to maintain the viewing geometry of this invention as detailed in FIG. 4.

Summarizing, the 3D model rotation calculator 16, 3D graphics engine 14, and delay frame buffer 44 are controlled such that the same single sequence of volumetric rendered monocular views 47 are viewed sequentially, but delayed in time, through the second eyepiece 49, with respect to the same sequence of volumetric rendered monocular views 47 being viewed through the first eyepiece 48.

The second eye frame buffer 53 stores each individual 3D volumetric monocular image view 45 contained in the sequence of volumetric rendered monocular views 47, appropriately delayed by delay frame buffer 44, while that individual 3D volumetric monocular image view 45 is transmitted to the 3D stereo viewer 4 for viewing by viewer second eye 2 through second eyepiece 49. After a period of time, the second eye frame buffer 53 is updated with the next individual 3D volumetric monocular image view 45 from the sequence of volumetric rendered monocular views 47 retrieved from delay frame buffer 44.

Concluding, the previously described components are controlled to maintain the angle theta 36 between the first eye perspective approximation line 37 of the viewer first eye 1 and the second eye approximation line 38 of the viewer second eye 2 viewing the 3D model 42 of object 10 through the first eyepiece 48 and the second eyepiece 49, respectively, of the 3D stereo viewer 4. This is done using a single sequence of volumetric rendered monocular views 47 viewed with appropriate delay, as previously described, by viewer first eye 1 and viewer second eye 2.

For human viewing, it is preferable to simultaneously update first eye frame buffer 13 and second eye frame buffer 53. The update frame rate will depend on the desired effect and processing speed of the components used to construct this invention, especially the 3D graphics engine 14.

Under certain circumstances, it may be desirable to stop rotation of the 3D model 42 of object 10 as viewed using the 3D stereo viewer 4. This provides the opportunity to study the 3D model 42 of the object 10 in detail without the distraction of a moving 3D model 42. To maintain stereo perception when the 3D model rotation calculator 16 stops rotating the 3D model 42, the delayed relationship between the individual views from the sequence of rendered monocular views in the first eye frame buffer 13, as viewed through first eyepiece 48, and the second eye frame buffer 53, as viewed through second eyepiece 49, must be maintained.

This is accomplished by simultaneously freezing both the individual view currently stored in the first eye frame buffer 13 and the individual view currently stored in the second eye buffer 53. Freezing these respective views from the sequence of volumetric rendered monocular views 47, with the view in the second eye buffer 53 delayed by the delay frame buffer 44, can be accomplished in several ways. One approach is to inhibit both first eye frame buffer 13 and second eye frame buffer 53 from accepting new inputs while maintaining their current output to the first eyepiece 48 and second eyepiece 49, respectively. Alternately, both the output of 3D graphics engine 14 and delay frame buffer 44 could be frozen while the first eye frame buffer 13 and second eye frame buffer 53 continue to operate.

As described in FIG. 4, this maintains the angle theta 36 between the first eye perspective approximation line 37 used by the viewer first eye 1 and the second eye approximation line 38 used by the viewer second eye 2 to view the 3D model 42 of object 10 such that stereo perception is maintained when looking at the still view through the first eyepiece 48 and second eyepiece 49 of the 3D stereo viewer 4.

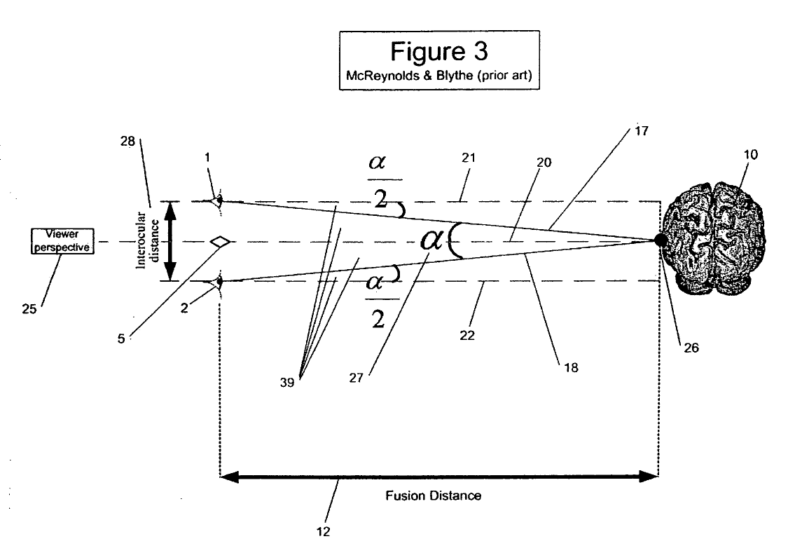

FIG. 3 shows the geometry of a stereo image viewing system in the prior art described by McReynolds and Blythe and offered as reference for explaining the nature of this invention. The viewer first eye 1 and viewer second eye 2 are separated by interocular distance 28. Viewer perspective reference 5 is located equidistant between and in the same vertical and horizontal planes as the viewer first eye 1 and viewer second eye 2. From John Wattie, Stereoscopic Vision: Elementary Binocular Physiology; nzpoto.tripod.com/sterea/3dvision.htm, the average human eye separation (i.e. interocular distance 28) is approximately 65 mm; the eyes are normally approximately equally spaced from the nose bridge (i.e. viewer perspective reference 5) with the average displacement of each eye from the nose bridge is then one-half the human interocular distance 28 or (0.5*I)=0.5*65 mm=32.5 mm.

Stereo fusion is the process by which the eye-brain creates the illusion of a single scene with relative depth perception. In humans, only a portion of each eye's field of view, called Pamum's Fusional Area, located around the eye's fovea can effectively fuse stereo images. With normal stereo viewing, the left and right eye fovea viewpoints converge at the convergence point 26, on the object 10 surface, increasing the potential that stereo fusion will occur in the region of the viewer's focus.

The first eye perspective view axis 17 is defined to be the direction of gaze fixation from the viewer first eye 1 to the convergence point 26 on the surface of 3D model 42 of object 10. The first eye infinite-viewing-distance line 21 is parallel to the viewer perspective line 20 and represents the direction of gaze fixation from the viewer first eye 1 to a virtual object located at an infinite distance from the viewer first eye 1.

Similarly, the second eye perspective view axis 18 is defined to be the direction of gaze fixation from the viewer second eye 2 to the convergence point 26. Also similarly, the second eye infinite-viewing-distance line 22 is parallel to the viewer perspective line 20 and represents the direction of gaze fixation from the viewer second eye 2 to a virtual object located at an infinite distance from the viewer second eye 2.

The first eye perspective view axis 17 and second eye perspective view axis 18 intersect at the convergence point 26 located on the surface of 3D model 42 of object 10 at fusion distance 12 from the viewer perspective reference 5 as measured along the viewer perspective line 20. The viewer perspective 25 is defined from the viewer perspective reference 5 viewing the 3D model 42 of object 10 along viewer perspective line 20 to the convergence point 26 on the surface of 3D model 42 of object 10 and is located fusion distance 12 from the 3D model 42 of object 10.

From geometry, the first eye infinite-viewing-distance line 21, second eye infinite-viewing-distance line 22 and viewer perspective line 20 are all parallel to each other and serve as reference lines for describing this system. Angle alpha 27 is the angle formed by the viewer first eye 1, first eye perspective view axis 17, convergence point 26, second eye perspective view axis 18 and viewer second eye 2. The viewer perspective line 20 bisects angle alpha 27. The angle formed by the first eye infinite-viewing-distance line 21, the viewer first eye 1, and the first eye perspective view axis 17 is congruent with the angle formed by the second eye infinite-viewing-distance line 22, the viewer second eye 2, and the second eye perspective view axis 18; these angles have measurement equal to angle (alpha/2) 39.

To achieve convergence on the object surface, the first eye perspective view axis 17 is therefore depressed from the first eye infinite-viewing-distance line 21 toward the viewer perspective line 20 by an angle (alpha/2) 39. Similarly, the second eye perspective view axis 18 is depressed from the second eye perspective infinite-viewing-distance line 22 toward the viewer perspective line 20 by an angle (alpha/2) 39.

Using trigonometry:
angle (alpha/2)=tan⁻¹ [(I/2)/F]
where: I is the interocular distance 28
F is the fusion distance 12
Solving for angle alpha 27, we have:
   angle alpha=2*tan⁻¹ [(I/2)/F]

FIG. 4 shows the geometry of the stereo image viewing system that is the subject of this invention. To achieve computational simplicity, a goal of this invention, the system geometry shown in FIG. 4 is constructed to approximate the geometry of the prior art system described in FIG. 3. Under many practical viewing situations found in 3D stereo medical image viewing applications, this approximation enables a single graphics engine, present in most medical Picture Archiving and Communication Systems (PACS), to drive a true 3D stereo viewer 4 from the same sequence of volumetric rendered monocular views 47 used to drive the traditional 2D medical diagnostic monitor.

The viewer first eye 1 and viewer second eye 2 are separated by interocular distance 28. Viewer perspective reference 5 is located equidistant between and in the same vertical and horizontal planes as the viewer first eye 1 and viewer second eye 2. The first eye infinite-viewing-distance line 21 is parallel to the viewer perspective line 20 and represents the direction of gaze fixation from the viewer first eye 1 to a virtual object located at an infinite distance from the viewer first eye 1. Similarly, the second eye infinite-viewing-distance line 22 is parallel to the viewer perspective line 20 and represents the direction of gaze fixation from the viewer second eye 2 to a virtual object located at an infinite distance from the viewer second eye 2. The viewer perspective 25 is defined from the viewer perspective reference 5 viewing the 3D model 42 of object 10 along viewer perspective line 20 to the convergence point 26 defined in FIG. 3 on the surface of 3D model 42 of object 10 and is located fusion distance 12 from the 3D model 42 of object 10.

The present invention differs from the prior art and achieves is computational simplicity and efficiency by not using the geometry defined by the first eye perspective view axis 17 intersecting with the second eye perspective view axis 18 at the convergence point 26 on the surface of 3D model 42 of object 10 as shown in the prior art in FIG. 3. Instead, the present invention defines the first eye perspective approximation line 37 to be the direction of gaze fixation from the viewer first eye 1 to the axis of rotation 3 of the 3D model 42 of object 10. Similarly, the second eye perspective approximation line 38 is defined to be the direction of gaze fixation from the viewer second eye 2 to the axis of rotation 3 of the 3D model 42 of object 10. Therefore, the first eye perspective approximation line 37 and the second eye perspective approximation line 38 intersect at the point defined to be the axis of rotation 3 of the 3D model 42 of object 10.

The axis of rotation 3 of the 3D model 42 of object 10 is defined to be perpendicular to the plane defined by the first eye perspective approximation line 37 and the second eye perspective approximation line 38. This enables rotation of 3D model 42 of object 10 around the axis of rotation 3 in direction of rotation 33 to produce horizontal binocular disparity in the images being simultaneously viewed by the viewer first eye 1 and the viewer second eye 2 using the 3D stereo viewer 4 as described in this invention. Distance R 7 is the projected linear distance along viewer perspective line 20, from the axis of rotation 3 defined in FIG. 4 to the convergence point 26 on the surface of the 3D model 42 of object 10 as described in FIG. 3 and shown for reference in FIG. 4.

Note that the axis of rotation 3 does not need to pass through the center of the 3D model 42 of object 10 for the invention to operate properly. However, for many objects, placement of the axis of rotation 3 though the center of 3D model 42 of object 10 may yield preferred results.

Note also that while the axis of rotation 3 is generally implemented collinear with viewer perspective line 20 as viewed in FIG. 4, this is also not a limitation of the invention. Defining the axis of rotation 3 non-collinear with viewer perspective line 20, will still provide stereo perception, with the 3D model 42 of object 10 appearing off to one side when viewed on the 3D stereo viewer 4. The symmetry of the system geometry described in FIG. 4 is slightly distorted when the axis of rotation 3 is not collinear with viewer perspective line 20, but the invention still provides a reasonable approximation to the prior art system shown in FIG. 3.

In practice, this variation is minimized by the user desire to see as much of the 3D model 42 of object 10 as possible. In practical use, the user tends to align the area of the 3D model 42 of object 10 being studied so that the area of interest is being imaged onto each of their eyes' retinas at or near the eye's fovea. Panum's fusional area is the limited area on the retina where retinal differences can be fused and interpreted as a 3D stereo rather than double vision. Since Panum's fusional area of the human retina roughly corresponds to the location of the human eye fovea, the user will naturally tend to position the 3D model 42 of the object 10 close to collinear with the viewer perspective line 20, enabling this invention to provide desirable 3D stereo viewing results.

While the axis of rotation 3 of the 3D model 42 of object 10 is ideally defined to be perpendicular to the plane defined by the first eye perspective approximation line 37 and the second eye perspective approximation line 38, this assumption can also be relaxed. Even for the ideal (i.e. perpendicular) orientation of the axis of rotation 3, rotation around it produces a small amount of undesirable vertical misalignment as well as the larger desired horizontal parallax. As the axis of rotation 3 moves away from the ideal perpendicular orientation, the amount of vertical misalignment induced is increased relative to the desired horizontal parallax (a dominant source of human stereoscopic vision) as the 3D model 42 of object 10 is rotated around the axis of rotation 3. As long as the undesirable vertical misalignment is kept relatively small, the viewer's brain is still able to successfully fuse the two separate images viewed by the viewer first eye 1 and viewer second eye 2 in the 3D stereo viewer 4 into a single stereoscopic image of the 3D model 42 of object 10. According to John Wattie, Stereoscopic Vision: Elementary Binocular Physiology, “The brain is tolerant of small differences between the two eyes. Even small magnification differences and small angles of tilt are handled without double vision.”

Further note that this invention will also allow the 3D model 42 of object 10 to be pre-oriented with respect to the geometric system defined in FIG. 4, prior to the definition of the axis of rotation 3 using the viewer perspective control device 24. The user may desire to do this to improve the view of key features of the 3D model 42 of object 10 based on user viewing preference and area of interest. Examples of this pre-orientation include but are not limited to, tilting the 3D model 42 toward the viewer perspective reference 5, rotating the 3D model 42 around the viewer perspective line 20, and rotating the 3D model 42 around it's vertical axis, or any combination of these pre-orientation operations. Once the 3D model 42 of object 10 is pre-oriented, the axis of rotation 3 is defined to satisfy the geometry of the invention described in FIG. 4. The pre-oriented 3D model 42 of object 10 is then rotated around the axis of rotation 3 defined relative to the pre-oriented 3D model 42 of object 10.

In FIG. 4 using geometry, the first eye infinite-viewing-distance line 21, second eye infinite-viewing-distance line 22 and viewer perspective line 20 are all parallel to each other and serve as reference lines for describing this invention. Angle theta 36 is the angle formed by the viewer first eye 1, the first eye perspective approximation line 37, axis of rotation 3 of 3D model 42 of object 10, the second eye perspective approximation line 38 and viewer second eye 2. The viewer perspective line 20 bisects angle theta 36. The angle formed by the first eye infinite-viewing-distance line 21, the viewer first eye 1 and the first eye perspective approximation line 37 is congruent with the angle formed by the second eye infinite-viewing-distance line 22, the viewer second eye 2 and the second eye perspective approximation line 38; these angles have measurement equal to angle (theta/2) 35.

To intersect at the object axis of rotation 3, the first eye perspective approximation line 37 is depressed from the first eye infinite-viewing-distance line 21 toward the viewer perspective line 20 by angle (theta/2) 35, where angle theta 36 is the angle formed between the first eye perspective approximation line 37 and the second eye perspective approximation line 38 as previously described. Similarly, the second eye perspective approximation line 38 is depressed from the second eye infinite-viewing-distance line 22 toward the viewer perspective line 20 by angle (theta/2) 35.

Using trigonometry:
angle (theta/2)=tan⁻¹ [(I/2)/(F+R)]
where: I is the interocular distance 28
   F is the fusion distance 12
      R is distance R 7 defined as the projected linear distance along viewer perspective line 20, from the axis of rotation 3 defined in FIG. 4 to the convergence point 26 on the surface of the 3D model 42 of object 10 as described in FIG. 3.
      Solving for angle theta 36, we have:
      angle theta=2*tan⁻¹ [(I/2)/(F+R)]

From this equation, as distance R 7 gets small compared with the fusion distance 12 and approaches zero, angle theta 36 approaches being equal to angle alpha 27 as shown below:

$$\begin{matrix}{lim}_{R -> 0} ( theta ) = {lim}_{R -> 0} \{ 2 * {tan}^{- 1} [ ( I / 2 ) / ( F + R ) ] \} \\ = 2 * {tan}^{- 1} [ ( I / 2 ) / F ] \\ = angle alpha\end{matrix}$$

For R<<F, angle theta 36 is a very good approximation of angle alpha 27.

Bourke describes a well-known criterion for natural appearing stereo in humans as being met when the ratio of fusion distance 12 to interocular distance 28 is on the order of 30:1. At ratios greater than 30:1, human stereo perception begins to decrease; human stereoscopic vision with the unaided eye becomes virtually non-existent beyond approximately 200 meters (ratio of approximately 3000:1). Ratios less than 30:1, especially ratios of 20:1 or less, give an increasingly exaggerated stereo sensation compared with normal unaided human eye viewing. This exaggerated stereo effect is generally referred to as hyper-stereo. Increasing this ratio results in reduced perception of stereo depth perceived by the viewer in the stereo image when compared to typical human experience in viewing natural scenes.

Substituting for the fusion distance 12 with thirty times the interocular distance 28 (F=30*I) in the previous equation for angle theta 36:
Angle theta=2*tan⁻¹ [(I/2)/(30*I+R)]=2*tan⁻¹ [(I/(60*I+2R)]
Estimating the magnitude of angle theta 36 under these conditions in this equation, it is clear that angle theta 36 is largest when R=0.

$$\begin{matrix}{lim}_{R -> 0} ( theta ) = 2 * {tan}^{- 1} [ ( I / ( 60 * I ) ] \\ = 2 * {tan}^{- 1} [ ( I / 60 ] \\ = 1.9 degrees ( where F = 30 * I )\end{matrix}$$

It can be seen from inspection of this equation that as distance R 7 increases, angle theta 36 decreases. Under the natural appearing stereo assumptions described by Bourke that lead to natural appearing stereo in humans:
Angle theta<=1.9 degrees

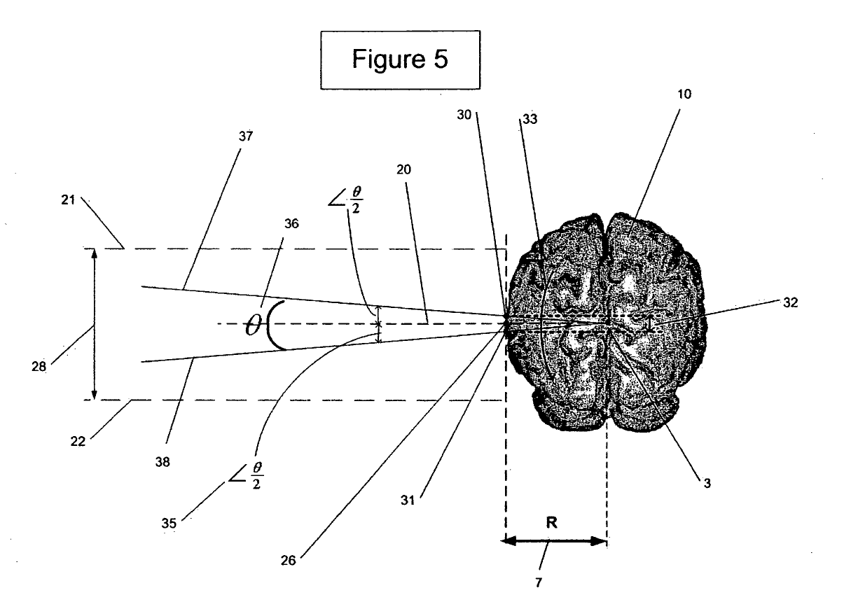

FIG. 5 is a more detailed view of Section A shown in FIG. 4, providing an enlarged view of the object 10 and the geometry of the invention. The axis of rotation 3 of 3D model 42 of object 10 with direction of rotation 33 is defined as in FIG. 4. The first eye perspective approximation line 37 intersects the surface of the 3D model 42 of object 10 at the first eye view surface intersection point 30. Similarly, the second eye perspective approximation line 38 intersects the surface of the 3D model 42 of object 10 at the second eye view surface intersection point 31. The distance between the first eye view surface intersection point 30 and the second eye view surface intersection point 31, measured perpendicular to the viewer perspective line 20, is the horizontal parallax error 32. Horizontal parallax error 32 is introduced by the geometry of this invention, specifically the assumption that first eye perspective approximation line 37 and second eye perspective approximation line 38 intersect at the axis of rotation 3 of 3D model 42 of object 10 as shown in FIG. 4 instead of intersecting at the convergence point 26 as shown in FIG. 3. For the case where the viewer perspective line 20 passes through the convergence point 26 and the axis of rotation 3, it bisects angle theta 36 into angle (theta/2) 35. The horizontal parallax error 32 is represented mathematically as:
horizontal parallax error=2*R*sin(theta/2)
where: R is distance R 7 defined as the projected linear distance along viewer perspective line 20, from the axis of rotation 3 defined in FIG. 4 to the convergence point 26 on the surface of the 3D model 42 of object 10 as described in FIG. 3.

From previous calculations when the criterion described by Bourke for natural appearing stereo in humans is met, angle theta <=1.9 degrees, therefore:
horizontal parallax error <=2*R sin(1.9/2)
<=2*R*(0.0166)
horizontal parallax error <=0.0332*R(less than 3.5% of R)

Again according to Wattie “the brain is tolerant of small differences between the two eyes. Even small magnification differences and small angles of tilt are handled, without double vision.”

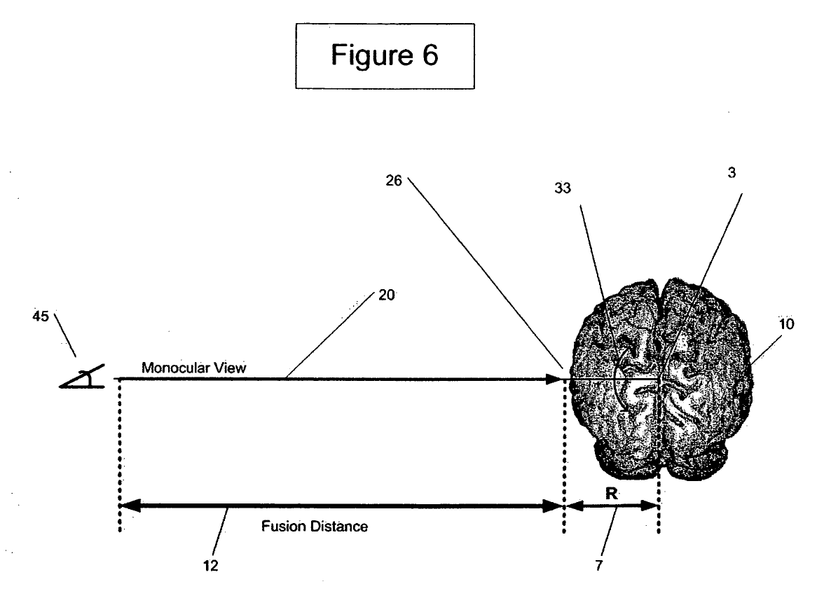

There are situations in medical image viewing when the previous assumptions on the interocular distance 28, fusion distance 12, and distance R 7 are satisfied. Therefore, it has been mathematically demonstrated that, when building a medical imaging system for viewing 3D stereo images, it is feasible to use the approximations of this invention to yield suitable 3D stereo viewing performance. Namely, that the first eye perspective approximation line 37 can be used to approximate the first eye perspective view axis 17 and second eye perspective approximation line 38 can be used to approximate the second eye perspective view axis 18 and that the first eye perspective approximation line 37 and second eye perspective approximation line 38 intersect at the axis of rotation 3 instead of at the convergence point 26 and that the 3D model 42 of object 10 is rotated around the axis of rotation 3 in the direction of rotation 33. This geometry is used to generate the sequence of volumetric rendered monocular views described in FIG. 2 and FIG. 4 and further explained in FIG. 6.

FIG. 6 shows a schematic of the geometry of a system for creating a 3D volumetric monocular image view 45 of 3D model 42 of object 10 for display on a non-stereo viewing system as known in the prior art. For example, currently available medical imaging systems are capable of displaying volumetrically rendered 3D medical image data on standard 2D radiographic diagnostic monitors as is done by the Kodak CareStream Picture Archiving and Communication System (PACS). To enable comparison with the current invention, the fusion distance 12, 3D model 42 of object 10, convergence point 26, axis of rotation 3, direction of rotation 33, viewer perspective line 20 and distance R 7 are labeled and defined as before.

As described by Bourke, “binocular disparity is considered the dominant depth cue in most people.” Current systems creating 3D volumetric monocular image view 45 do not enable the viewer to perceive true stereo depth. These systems are incapable of creating binocular disparity since the identical 3D volumetric monocular image view 45 of 3D model 42 of object 10 seen by viewer first eye 1 is also simultaneously being as seen by viewer second eye 2, usually on a 2D flat-panel LCD monitor. To create binocular disparity, 3D volumetric monocular image view 45 of 3D model 42 of object 10 seen by viewer first eye 1 must be different from the 3D volumetric monocular image view 45 seen by the viewer second eye 2.

Despite the inability to create binocular disparity, systems that create a single 3D volumetric monocular image view 45 at a time do generate other weaker human-perceivable depth cues in the image by using well-known artistic techniques also summarized by Bourke. Occlusion and relative motion are commonly used by current medical systems capable of rendering a 3D volumetric monocular image view 45 systems. These 3D model 42 of object 10 can be rotated until the axis along which it is desired to determine depth information is aligned with the plane of the 2D viewing device, i.e. the dimension the viewer wishes to see is displayed across the face of the 2D viewing device. Depth information is visualized as the viewer is looking perpendicular to the dimensions they wish to measure.

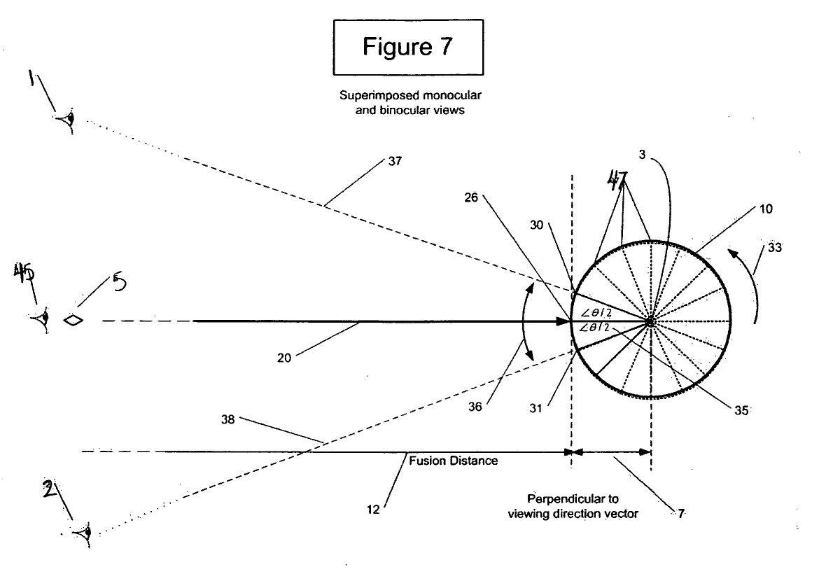

FIG. 7 shows a schematic representation of the 3D volumetric monocular image view 45 system from FIG. 6 superimposed with the key components of the current invention described in FIG. 5. A circle is used to represent the 3D model 42 of object 10. As previously defined, 3D model 42 of object 10 is rotated around the axis of rotation 3 in the direction of rotation 33. The axis of rotation 3 is shown perpendicular to the plane formed by the first eye perspective approximation line 37 and the second eye perspective approximation line 38 as previously defined in FIG. 4. Angle theta 36 is the angle between the first eye perspective approximation line 37 and the second eye perspective approximation line 38. The first eye perspective approximation line 37 intersects the surface of the 3D model 42 of object 10 at the first eye view surface intersection point 30. The second eye perspective approximation line 38 intersects the surface of the 3D model 42 of object 10 at the second eye view surface intersection point 31.

3D volumetric monocular image view 45 is defined from the viewer perspective reference 5 at fusion distance 12 from the convergence point 26 defined by the intersection of the viewer perspective line 20 and the surface of 3D model 42 of object 10. Distance R 7 is the distance from the axis of rotation 3 to the convergence point 26 at the intersection of the viewer perspective line 20 and the surface of 3D model 42 of object 10.

Control the rotation speed of the 3D model 42 of object 10 in the direction of rotation 33 around axis of rotation 3 such that the angle swept out in a given time period it is equal to angle (theta/2) 35. Further define a vector originating at the axis of rotation 3 and passing through first eye view surface intersection point 30 at initial time and rotating with the 3D model 42 of object 10. At the end of the first time period, the vector is passing through convergence point 26. At the end of the second time period, the vector is passing through second eye view surface intersection point 31. Vectors extending from the axis of rotation 3 through a given point on the surface of the 3D model 42 of object 10 and moving in the direction of rotation 33 around axis of rotation 3.

To further explain the geometry of the invention described in FIG. 7, consider the analogy of a lighthouse. The lighthouse beacon originates at the center of the light tower and projects into the night. In the analogy, the viewer first eye 1, viewer perspective reference 5 and viewer second eye 2 can be represented by three observation points along the gunwale of a ship traveling parallel to the lighthouse shoreline. As the beacon rotates, it's light will sequentially illuminate the observation positions on the ship corresponding to the viewer first eye 1, viewer perspective reference 5 and viewer second eye 2. The viewer first eye 1 will be illuminated when the lighthouse beacon direction corresponds to the first eye perspective approximation line 37. The viewer perspective reference 5 will be illuminated when the lighthouse beacon direction corresponds to viewer perspective line 20. The viewer second eye 2 will be illuminated when the lighthouse beacon direction corresponds to the second eye perspective approximation line 38.

Taking the lighthouse analogy further, assume the lighthouse has two beacons, a first beacon and a second beacon in the same plane with respect to each other and moving in the direction of rotation 33 around the axis of rotation 3, separated from each other by angle theta 36. As the dual lighthouse beacons rotate, there will exist an instant in time when the first beacon is passing through the first eye view surface intersection point 30 and illuminates the first observer representing the viewer first eye 1 while at the same instant, the second lighthouse beacon passed through the second eye view surface intersection point 31 and illuminates the second observer representing the viewer second eye 2.

Generalizing the previous lighthouse analogy, the lighthouse may have multiple beacons, with each beacon located at an angle theta 36 from its previous and subsequent beacon. This corresponds to a sequence of volumetric rendered monocular views 47 rendered by 3D graphics engine 14 of the 3D model 42 of object 10, where each 3D volumetric monocular image view 45 is separated by angle theta 36 from its previous and subsequent 3D volumetric monocular image view 45 while the 3D model 42 of object 10 is rotated in the direction of rotation 33 around axis of rotation 3.

FIG. 8 describes the further invention of microstepping the rotation of 3D model 42 of object 10 at microstep increment angle 43, such that microstep increment angle 43 is less than angle theta 36, in the direction of rotation 33 around axis of rotation 3. Microstepping creates a sequence of volumetric rendered monocular views 47 rendered by 3D graphics engine 14 of the 3D model 42 of object 10 such that a 3D volumetric monocular image view 45 is created for each microstep increment angle 43. Since the microstep increment angle 43 is less than angle theta 36, the sequence of volumetric rendered monocular views 47 rendered using the microstep increment angle 43 will contain more 3D volumetric monocular image view 45 for a complete revolution of the 3D model 42 of object 10 than the sequence of volumetric rendered monocular views 47 rendered using an angle theta 36 increment.

Having more “in-between” 3D volumetric monocular image view 45 in the sequence of volumetric rendered monocular views 47 using microstep increment angle 43 enhances the perceived smoothness of 3D model 42 of object 10 rotation around the axis of rotation 3. Using the microstep increment angle, each 3D volumetric monocular image view 45 represents a smaller change from the previous and subsequent 3D volumetric monocular image view 45 in the sequence of volumetric rendered monocular views 47.

In the system of this invention, using the microstep increment angle to control the rotation of the 3D model 42 of object 10 performs a function similar to an animated motion picture “in-betweener.” “In-betweeners” create additional animated motion picture frames between key animation frames drawn by more experienced master animators, improving the animated motion smoothness and perceived quality.

When using the microstep increment angle to control the rotation of the 3D model 42 of object 10 around the axis of rotation 3, an angle theta 36 must be maintained between the 3D volumetric monocular image view 45 representing the view of 3D model 42 of object 10 along the first eye perspective approximation line 37 and the 3D volumetric monocular image view 45 representing the view of 3D model 42 of object 10 along the second eye perspective approximation line 38 to provide natural stereo depth perception when viewing 3D model 42 of object 10 using 3D stereo viewer 4.

Selecting the microstep increment angle 43 such that it evenly divides into the angle theta 36 has the added benefit of allowing an exact number of “in-between frames” to be created between the “key frames.” This is not required by the current invention to operate, but may improve display results.

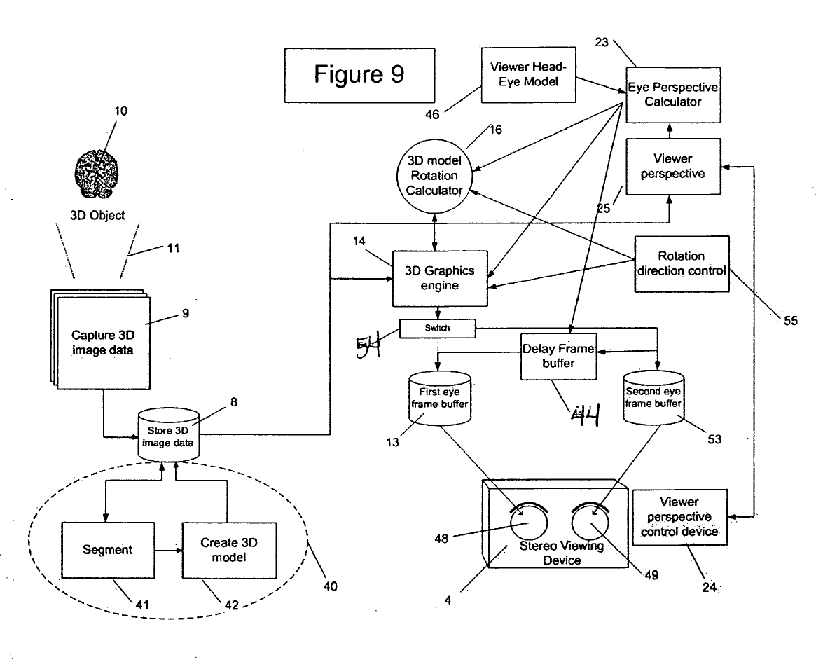

FIG. 9 shows the addition to the present invention needed when it is desirable to reverse the direction of rotation 33 of the 3D model 42 of object 10 being viewed using the 3D stereo viewer 4. In situations when only a portion of the 3D model 42 of object 10 contains the region of interest to be viewed, it is not efficient to continue to rotate the 3D model 42 of object 10 in complete (i.e. 360 degree) rotations in the current direction of rotation 33 around the axis of rotation 3. There are several alternatives for the user to control the current invention in cases of limited desired viewing area. The user can stop rotation of the 3D model 42 of object 10, as previously described, thus maintaining a still stereo image as viewed using the 3D stereo viewer 4.

Alternately, the user can limit the range of rotation in the direction of rotation 33 around axis of rotation 3 so that only the portion of 3D model 42 of object showing the region of interest is rotated into view. Once the rotation is complete, the 3D model 42 of object 10 is reset to the initial position and the rotation cycle is repeated.

Another alternative enabled by the addition of graphics engine output switch 54 and rotation direction control 55 in FIG. 9. Graphics engine output switch 54 control the output of 3D graphics engine 14 to either:
drive the input to first eye frame buffer 13 directly with the delay frame buffer 44 and 3D model rotation calculator 16 working as previously described. The input to second eye frame buffer 53 is processed through the delay frame buffer 44 as shown in FIG. 2. (or)
reverse the direction of delay frame buffer 44, using graphics engine output switch 54 to switch the output of 3D graphics engine 14 to drive the input to second eye frame buffer 53 directly as well as and the other side of the delay frame buffer 44 directly. Input to first eye frame buffer 13 will be delayed by the “reversed” delay frame buffer 44 as shown in FIG. 9.

This approach has the benefit of having the 3D model 42 of object 10 appear to oscillate, rotating back and forth through the region of interest.

The present invention will be directed in particular to elements forming part of, or in cooperation more directly with the apparatus in accordance with the present invention. It is to be understood that elements not specifically shown or described may take various forms well known to those skilled in the art.

The invention has been described in detail with particular reference to certain preferred embodiments thereof, but it will be understood that variations and modifications can be effected within the scope of the invention.

### PARTS LIST

1 viewer first eye
2 viewer second eye
3 axis of rotation
4 3D stereo viewer
5 viewer perspective reference
7 distance R
8 data storage
9 medical image data
10 3D object
11 scanner
12 fusion distance
13 first eye frame buffer
14 graphics engine
15 first eye perspective
16 3D model rotation calculator
17 first eye perspective view axis
18 second eye perspective view axis
20 viewer perspective line
21 first eye infinite-viewing-distance line
22 second eye infinite-viewing-distance line
23 eye perspective calculator
24 viewer perspective control device
25 viewer perspective
26 convergence point
27 angle alpha
28 interocular distance
30 first eye view surface intersection point
31 second eye view surface intersection point
32 horizontal parallax error
33 direction of rotation
35 angle (theta/2)
36 angle theta
37 first eye perspective approximation line
38 second eye perspective approximation line
39 angle (alpha/2)
40 3D modeling process
41 image segmentation
42 3D model
43 microstep increment angle
44 delay frame buffer
45 3D volumetric monocular image view
46 viewer head-eye model
47 sequence of volumetric rendered monocular views
48 first eyepiece
49 second eyepiece
53 second eye frame buffer
54 graphics engine output switch
55 rotation direction control

1. A system for analyzing radiological images using three-dimensional (3D) stereo pairs comprising:
capturing 3D image data;
storing said 3D image data;
segmenting said 3D image data;
creating a model from said segmented 3D image data;
creating a first 3D volumetric monocular-view image for a current model position;
rotating said model a prescribed amount and creating a second 3D volumetric monocular-view image for the rotated position;
creating said 3D stereo pair using the first and second 3D volumetric monocular-view images; and
viewing said 3D stereo pair on a 3D stereo viewer.

2. A system for analyzing radiological images using three-dimensional (3D) stereo pairs comprising:
capturing 3D image data;
storing said 3D image data;
segmenting said 3D image data;
creating a model from said segmented 3D image data;
creating a first 3D volumetric monocular-view image for a first model position;
rotating said model to a second position;
creating a second 3D volumetric monocular-view image for said second position;
creating said 3D stereo pair using the first and second 3D volumetric monocular-view images;
viewing said 3D stereo pairs on a stereo viewing device;
rotating said model incrementally to create a sequence of model positions;
creating a sequence of 3D stereo pair for each of said sequential model positions; and
viewing said 3D stereo pair sequences on a 3D stereo viewer 4.

3. A system for analyzing radiological images as a claim 1 wherein said 3D image data comprises medical tomographic data.

4. A system for analyzing radiological images as a claim 1 wherein:
a first image of each of said 3D stereo pairs is transmitted to a first eye;
a second image of each of said 3-D stereo pairs is transmitted to a second eye; and
wherein there is a one frame delay between said first and second image.

5. A system for analyzing radiological images as a claim 4 wherein a direction of rotation of said model is from said first eye to said second eye.

6. A system for analyzing radiological images as a claim 1 wherein said 3D image is displayed on a positional 3D autostereoscopic apparatus.

7. A system for analyzing radiological images as a claim 1 wherein said 3D image data comprises a plurality of two-dimensional (2D) radiographic images.

8. A method for viewing medical images using three-dimensional (3D) stereo pairs comprising:
capturing 3D image data;
segmenting said 3D image data;
creating a model from said segmented 3D image data;
creating a plurality of said 3D stereo pairs;
rotating said model to create a 3D image;
displaying a first image of each of said 3D stereo pairs on a first display;
displaying a second image of each of said 3D stereo pairs on a second display;
wherein a direction of rotation of said model is from said first display to said second display; and
wherein second image is one frame behind said first image.

9. A method for viewing medical images as in claim 8 wherein rotation about an axis creates horizontal parallax between said model viewed from said first and second display.

10. A method for viewing medical images as in claim 9 wherein said axis is perpendicular to a viewing plane.

11. A method for viewing medical images as in claim 8 wherein stopping said rotation maintains horizontal parallax between said stereo pair.

12. An apparatus for three-dimensional (3D) display of images comprising:
a camera for capturing image data;
a computer for segmenting said image data;
a program for creating a 3D model from said segmented image data and for rotating said model;
a display comprised of a first imager and a second imager;
wherein a first image frame is presented sequentially to said first imager and then to said second imager; and
wherein a direction of rotation of said model is from said first imager to said second imager.

13. An apparatus for three-dimensional (3D) display of images as in claim 12 wherein said program comprises a microchip.

14. A method for viewing medical images using three-dimensional (3D) stereo pairs comprising:
capturing 3D image data;
segmenting said 3D image data;
creating a model from said segmented 3D image data;
creating a plurality of said 3D stereo pairs;
rotating said model to create a 3D image;
displaying a first image of each of said 3D stereo pairs on a first display;
displaying a second image of each of said 3D stereo pairs on a second display;
rotating said model in a first direction to create a 3D image;
wherein said first direction of rotation of said model is from said first display to said second display;
wherein second image is one frame behind said first image;
rotating said model in a second direction to continue viewing said 3D image;
wherein said second direction of rotation of said model is from said second display to said first display; and
wherein said first image is one frame behind said second image.

15. A method of viewing medical images as in claim 14 wherein each of said 3D stereo pairs are fused at an axis of rotation.

16. A method of viewing medical images as in claim 14 comprising:
stopping said rotation in a second direction; and
maintaining stereo pairs information in a buffer.

17. A system for analyzing radiological images using three-dimensional (3D) stereo pairs comprising:
segmenting 3D image data;
creating a model from said segmented 3D image data;
creating a first 3D volumetric monocular-view image for a first model position;
rotating said model to a second position;
creating a second 3D volumetric monocular-view image for said second position;
creating a first 3D stereo pair using said first and second 3D volumetric monocular-view images;. and
viewing said 3D stereo pairs on a 3D stereo viewer.
